(19) United States
(12) Patent Application Publication
(10) Pub. No.: US 2005/0115424 A1
(43) Pub. Date: Jun. 2, 2005

(54) Digital printing method and printing device having a cup-shaped printing carrier

(76) Inventor: Manfred Wiedemer, Ismaning (DE)

Correspondence Address: SCHIFF HARDIN, LLP;PATENT DEPARTMENT, 6600 SEARS TOWER, CHICAGO, IL, 60606-6473, US

(21) Appl. No.: 10/504,762

(22) PCT Filed: Feb. 19, 2003
(86) PCT No.: PCT/EP03/01697

(30) Foreign Application Priority Data
Feb. 19, 2002 (DE) 102 06 936.0

(51) Int. Cl. B41F 9/00

(52) U.S. Cl. 101/153; 101/453

(57) ABSTRACT

In a method and device to print a carrier material, a print carrier is provided with depressions on a surface. On the surface, a fluid layer is applied such that the depressions are filled with fluid. In a structuring process, ink-attracting and ink-repelling regions are generated so that the fluid in the depressions is removed in the ink-attracting regions not removed in the ink-repelling regions. Ink that adheres in the ink-attracting regions and which does not adhere in the ink-repelling regions is applied on the surface. The ink applied on the surface of the print carrier is transferred to the carrier material.

### BACKGROUND

In a method and a device to print a carrier material, a print carrier has a plurality of depressions on its surface. Such a print carrier is, for example, known from the rotogravure technique.

Digitally operating print methods have been known in which a structuring in ink-attracting and ink-repelling regions is effected via digitally controlled energy sources, for example lasers. Before the restructuring of the same surface of the print carrier, the respective surface is to be cleaned precisely. For this, corresponding cleaning stations are necessary that increase the hardware expenditure.

For example, from U.S. Pat. No. 5,067,404 a digitally-operating print method is known in which a fountain solution is applied to the surface of the print carrier. The fountain solution is vaporized via selective application of radiant energy in image regions. The water-free regions later form the ink-bearing regions that are directed to a developing unit and are inked by means of an ink vapor. After the transfer printing, the ink residues must be completely removed from the surface of the print carrier in order to reapply a fountain solution and to restructure this.

Furthermore, from U.S. Pat. No. 6,295,928 (corresponding to WO 98/32608), a method is known in which an ice film is applied to the surface of the print carrier and this ice film is structured with the aid of local thermal energy, whereby, for example, a digitally-controlled laser system is used. After the transfer printing, the ice layer and the ink residues must be removed in order to enable a restructuring with new print images.

From DE-A-101 32 204 (not published) by the same applicant, a CTP method (Computer-To-Press method) is specified whereby multiple structuring processes can be implemented on the same surface of the print carrier. The structuring into ink-attracting and ink-repelling regions is effected with the aid of digitally-controlled systems, for example laser systems. The ink-attracting regions are later inked with ink. The surface of the print carrier is cleaned before a new structuring process.

Cleaning devices that can be used for digitally-operating print methods are, for example, specified in DE-A-100 63 987 by the same applicant. For cleaning, the surface of the print carrier is charged with cleaning fluid, whereby further measures (such as the use of ultrasound energy) can be added.

From WO 01/02170 A by the same applicant, a method and a print device to print a carrier material and to clean a printing roller are known. The print carrier comprises a plurality of depressions in which ink can be accepted. In a structuring process, this ink in the depressions is charged with a thermal energy, whereby ink-printing regions and regions that emit no ink are generated. The surface of the print carrier is completely cleaned with the aid of a complex cleaning station before a restructuring.

DE 102 08 250 A1 (not published) specifies a printing method in which the surface of a print carrier is wetted with a fountain solution. With the aid of energy, the fountain solution is removed at image locations, the surface is inked and the ink is transferred to an intermediate carrier, for example a rubber blanket band. From there, the ink is transferred to a carrier material. The surface of the print carrier is respectively cleaned between two print cycles.

DE 195 03 951 C2 and EP 0 711 671 A1 are referenced as further prior art.

### SUMMARY

It is an object of the invention to specify a printing method and a print device that permits different print images to be generated on the same surface of the print carrier, whereby the cleaning expenditure is minimized.

In a method and device to print a carrier material, the print carrier is provided with depressions on a surface of the print carrier. On the surface of the print carrier, a thin, homogenous fluid layer is applied such that the depressions fill with fluid. In a structuring process, ink-attracting and ink-repelling regions are generated so that the fluid in the depressions is removed in the ink-attracting regions and the fluid is not removed in the ink-repelling regions. Ink that adheres in the ink-attracting regions and does not adhere in the ink-repelling regions is applied on the surface. The ink applied on the surface of the print carrier is transferred to the carrier material. A fluid layer is reapplied on the same surface of the print carrier and the print process is continued.

### BRIEF DESCRIPTION OF THE DRAWINGS

FIG. 1 is a side view of a print device for printing a carrier material.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

In a method to print a carrier material, a print carrier has a plurality of depressions on its surface. On the surface of the print carrier, a thin, homogenous fluid layer is applied, such that all depressions fill with fluid. In a structuring process, ink-attracting and ink-repelling regions are generated, whereby the fluid is removed in the depressions in ink-attracting regions and in ink-repelling regions the fluid is not removed. Ink that adheres in ink-attracting regions and does not adhere in ink-repelling regions is applied to the surface. The ink applied on the surface of the print carrier is, in the further course, directly transferred to the carrier material. A fluid layer is reapplied on the same surface of the print carrier and the print process is continued.

All depressions that in general have a cup shape are filled with fluid, for example water. In a subsequent structuring process that is generally digitally controlled, the fluid in the depressions in ink-attracting regions is removed, for example via vaporization. The fluid is still present in the depressions in the ink-repelling regions. The total usable surface of the print carrier is then inked with ink that is repelled by the fluid, but however is accepted by the depressions without fluid. The carrier material, for example paper, now comes into direct contact with the surface. The ink is thereby completely transferred from the depressions to the carrier material. After the transfer printing, all depressions are empty and also contain no ink residues. Consequently, the thin, homogenous fluid layer can immediately be applied again in the next process step and a restructuring into ink-repelling and ink-attracting regions can occur. A cleaning between two print cycles is thus foregone, whereby a corresponding cleaning station can be omitted. The hardware expenditure for the realization of the method is thus reduced. It can be possible that a cleaning is necessary in a simplified form after large temporal intervals. However, in general such a cleaning is not necessary between two successive print cycles, but rather only after a large number of print cycles and also then only in a simplified form of the cleaning, such that the cleaning expenditure is then also reduced. High printing speeds can consequently be achieved given application of a digital printing method.

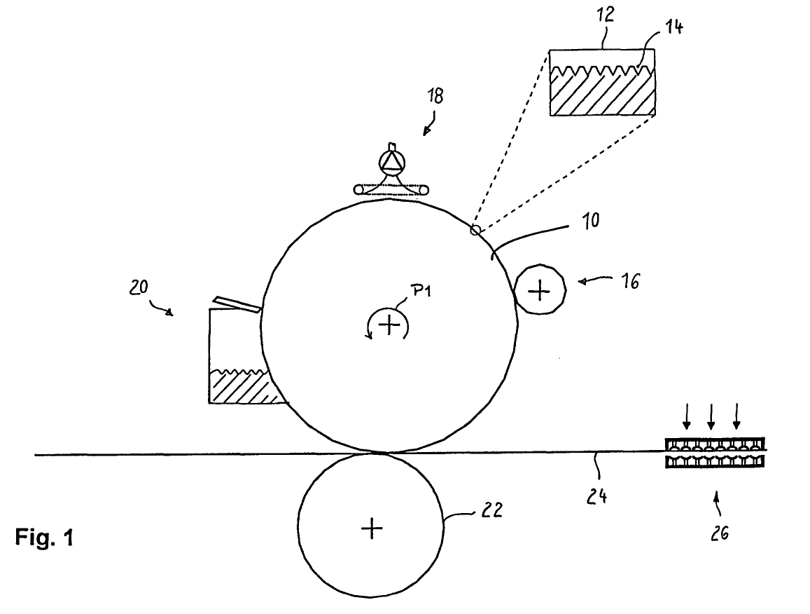

In FIG. 1, a print device is shown via which the specified method for printing of a carrier material can be realized. A print carrier 10, also designated as a form cylinder, has a surface structure that is shown enlarged in image section 12. The surface structure comprises cups 14 arranged two-dimensionally in a grid, for example in a grid of 300 to approximately 2500 dpi (dots per inch), preferably 600 to 1200 dpi. Corresponding image points can be printed with the aid of these cups. The cup is depth 0.1 to 50 μm, preferably 5 to 20 μm.

A dampening system 16, an image generation device 18, an inking system 20 and a counter-pressure cylinder 22 (also called an “impression roller”) are arranged around the circumference of the cylindrical print carrier 10. The carrier material 24 is conducted through between the cylindrical print carrier 10 and the counter-pressure cylinder 22. It passes through a drying station 26 for drying.

Given rotation of the print carrier 10 in the arrow direction P1, the application of a thin, homogenous fluid layer occurs on the dampening system 16, such that all cups 14 fill with fluid, preferably water. The fountain solution application occurs, for example, via rollers, however the application can also alternatively occurs via spraying or vapor deposition.

Excess fountain solution is preferably removed with a scraper (not shown) which is downstream from the dampening system 16. The fountain solution is selectively vaporized via a digitally-operating image generation device 18, whereby ink-attracting and ink-repelling regions are generated. In the ink-attracting regions, the fluid in the cups 14 is removed; in the ink-repelling regions, the fountain solution is not removed. The image generation device 18 can, for example, be a digitally-controlled laser or a differently-controlled energy source. Via the inking system 20, ink that adheres to the surface of the print carrier 10 in the ink-attracting regions and does not adhere in the ink-repelling regions is applied on the surface of the print carrier 10. Given use of a water-containing fountain solution, the ink is generally oil-containing. Excess ink is removed via a scraper (not shown) downstream from the inking system 20.

The printing ink is subsequently directly transfer printed to the carrier material 24. The transfer onto the elastic intermediate carrier as specified in the patent document U.S. Pat. No. 5,295,928 is omitted. The ink transfer is effected via adhesion forces. Via corresponding execution of the printing ink with regard to its viscosity and cross-linkage, as this is known, and via suitable design of the cup shape, one achieves a very good emptying of the cups 14. Printing inks based on water, as this is used in known rotogravure methods, are preferred given use of print carriers with relatively large cup depths and their problem of complete emptying.

The carrier material is subsequently directed through a drying station 26 that dries the ink.

As mentioned, a fountain solution that comprises water is preferably used. Wetting-aiding substances, for example surfactant, can then be added to the fountain solution. Alternatively, silicon-repelling fluids can also be used in order to process silicon-containing printing inks.

In the region of the transfer printing location, an electrostatic field can be applied in order to support the emptying of the ink from the cups 14 in the surface of the print carrier 10.

As mentioned, no cleaning station is arranged between the transfer printing and the reapplication of fountain solution. The cups 14 are completely emptied. After a reapplication of fountain solution, a structuring in ink-attracting and ink-repelling regions can occur, either corresponding to the previous print image or corresponding to a new print image. In this manner, print images of smaller and larger editions can be printed with the same print carrier with high flexibility. Due to the omission of the cleaning process, which can be necessary only in simplified form and at substantially larger temporal intervals, an increased print speed can be achieved relative to the previous digital printing method.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1-19. (canceled)

20. A method to print a carrier material, comprising the steps of:
providing a print carrier with a plurality of depressions on a surface of the print carrier;
applying on the surface of the print carrier a thin, homogenous fluid layer such that all of the plurality of depressions fill with fluid;
in a structuring process, generating ink-attracting and ink-repelling regions so that the fluid in the depressions is removed in ink-attracting regions and the fluid is not removed in the ink-repelling regions;
applying on the surface ink that adheres in the ink-attracting regions and does not adhere in the ink-repelling regions;
directly transferring to the carrier material the ink applied on the surface of the print carrier; and
reapplying a fluid layer on the same surface of the print carrier and continuing the print process, a plurality of print cycles following one another occurring without the surface of the print carrier being cleaned.

21. A method according to claim 20 wherein the depressions form a cup structure with a cup depth in a range of 0.1 to 50 μm.

22. A method according to claim 20 wherein the cups are arranged in a grid of 300 to 2500 dpi, on a usable surface of the print carrier.

23. A method according to claim 20 wherein the fluid comprises water.

24. A method according to claim 23 wherein wetting-aiding substances are added to the water-containing fluid.

25. A method according to claim 20 wherein the fluid comprises silicon-repelling substances and the ink comprises silicon-containing substances.

26. A method according to claim 20 wherein excess fluid is removed by a scraper after application of the fluid.

27. A method according to claim 20 wherein excess ink is removed with aid of a scraper after the application of the ink.

28. A method according to claim 20 wherein in a region of the transfer printing location, an electrostatic field is effective that supports emptying of the ink from the depressions in the surface of the print carrier.

29. A method according to claim 20 wherein the printed carrier material is dried.

30. A method according to claim 20 wherein the print carrier is one of cylindrical and disc-shaped.

31. A device to print a carrier material, comprising:
a print carrier having a surface and a plurality of depressions therein;
an applicator which applies a thin, homogenous fluid layer on the surface such that all of the plurality of depressions are filled with fluid;
an image generator which generates ink-attracting and ink-repelling regions in a structuring process whereby the fluid in the depressions is removed in the ink-attracting regions and the fluid is not substantially removed in the ink-repelling regions;
an ink applying station where ink that adheres in the ink-attracting regions on the surface of the print carrier and does not adhere in ink-repelling regions is applied to the surface of the print carrier;
an ink transfer printing station where ink applied on the surface of the ink carrier is directly transferred to the carrier material;
the applicator reapplies a fluid layer on the same surface of the print carrier after the ink transfer; and a plurality of print cycles follow one another without the surface of the print carrier being cleaned; and
at the ink transfer printing station an electrostatic field generator that supports the emptying of the ink from the depressions in the surface of the print carrier.

32. A device according to claim 31 in which the depressions form a cup structure with a cup depth in a range of 0.1 to 50 μm.

33. A device according to claim 31 in which the cups are arranged in a grid of 300 to 2500 dpi on the usable surface of the print carrier.

34. A device according to claim 31 in which the fluid comprises water.

35. A device according to claim 34 in which wetting-aiding substances are added to the water-containing fluid.

36. A device according to claim 31 wherein the fluid comprises silicon-repelling substances and the ink comprises silicon-containing substances.

37. A device according to claim 31 wherein the printed carrier material is dried.

38. A device according to claim 31 wherein the print carrier is one of cylindrical and disc-shaped.

39. A method to print a carrier material, comprising the steps of:
providing a print carrier with depressions on a surface of the print carrier;
applying on the surface of the print carrier a thin, homogenous fluid layer which fills the depressions with fluid;
in a structuring process, generating ink-attracting and ink-repelling regions so that the fluid in the depressions is substantially removed in the ink-attracting regions and the fluid is not substantially removed in the ink-repelling regions;
applying on the surface ink that adheres in the ink-attracting regions and does not adhere in the ink-repelling regions; and
transferring to the carrier material the ink applied on the surface of the print carrier.

40. A device to print a carrier material, comprising:
a print carrier having a surface and depressions therein;
an applicator which applies a thin, homogenous fluid layer on the surface to fill the depressions with fluid;
an image generator which generates ink-attracting and ink-repelling regions whereby the fluid in the depressions is removed in the ink-attracting regions and the fluid is not substantially removed in the ink-repelling regions; and
an ink applying station where ink that adheres in the ink-attracting regions on the surface of the print carrier and does not adhere in ink-repelling regions is applied to the surface of the print carrier;
an ink transfer printing station where ink applied on the surface of the ink carrier is transferred to the carrier material; and
the applicator reapplies a fluid layer on the same surface of the print carrier after the ink transfer.
